(19) United States
(12) Patent Application Publication
(10) Pub. No.: US 2008/0249885 A1
(43) Pub. Date: Oct. 9, 2008

(54) SYSTEMS AND METHODS FOR PROVIDING AN INTERNET ASSET MARKETPLACE

(75) Inventors: CHYR-CHONG JOSEPH TING, SAN JOSE, CA (US); ADAM HYDER, LOS ALTOS, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: YAHOO! INC., SUNNYVALE, CA (US)

(21) Appl. No.: 11/696,148

(22) Filed: Apr. 3, 2007

(51) Int. Cl. G06Q 30/00

(52) U.S. Cl. 705/26

(57) ABSTRACT

Methods and systems of providing a market for Internet assets are disclosed. A format protocol for implementing Internet assets is established. The format protocol is established by the marketplace provider. Asset metadata associated with an Internet asset can be received from an asset provider. The Internet asset is implemented using the established format protocol. An asset listing is posted on an online market of assets. The asset listing can include a portion of the asset metadata. A request for the Internet asset can be received. The request can be received from an asset consumer that can invoke the Internet asset using the format protocol.

### BACKGROUND

1. Field

The present disclosure relates to web services and other Internet assets. In particular, it relates to systems and methods of providing a marketplace of web services, and other Internet assets.

2. General Background

As audiences move toward online websites for content, offline media companies are partnering with larger online media companies. Currently, there are some co-branded sites where the supply of content and audience is shared between online and offline companies. Conventional partnerships are formed by partners contacting one another. In addition, web services and other widgets are also shared by direct contact from one party to another.

### SUMMARY

In one aspect, there is a method of providing a market for web services. A format protocol for implementing a web service is established. The format protocol is established by the marketplace provider. A web service metadata associated with a web service is received from an asset provider.

Web service computer code associated with a web service is received from the asset provider. The web service computer code is implemented using the established format protocol. A web service listing is posted on an online market of assets. The web service listing can include a portion of the web service metadata. A request for the web service is received. The request being received from an asset consumer that can invoke the web service using the format protocol.

In a further aspect of the method, the web service computer code is executed. A result of the web service to the asset consumer is returned upon executing the web service computer code. The web service computer code can be compiled and executed. The format protocol includes a parameter data format indicative of a format in which parameters are to be passed to the web service. In another aspect, the format protocol can also include a return data format indicative of a format in which return data is provided to the asset consumer once the web service is executed.

In one aspect, there is a method of providing a market for Internet assets. A format protocol for implementing Internet assets is established. The format protocol is established by the marketplace provider. Asset metadata associated with an Internet asset can be received from an asset provider. The Internet asset is implemented using the established format protocol. An asset listing is posted on an online market of assets. The asset listing can include a portion of the asset metadata. A request for the Internet asset can be received. The request can be received from an asset consumer that can invoke the Internet asset using the format protocol.

In another aspect, the Internet asset is a software module, a web service, a web widget, a business entity brand, or a space of a website.

In yet another aspect, the request for the Internet asset is a request to include a brand of the asset provider on a website of the asset consumer. In another aspect, the request for the Internet asset is a request for space on a webpage of the asset provider such that the asset consumer can place asset consumer data on the webpage of the asset provider.

In a further aspect, parameter data can be received from the asset consumer. The parameter data can be transmitted to the asset provider. Return data can be received from the asset provider. The return data can be provided to the asset consumer. In a further aspect of the method, computer code corresponding to the Internet asset can be received and executed.

In a further aspect, there is a a link that references a network location of the asset consumer.

In one aspect, there is a system of providing a market for web services, comprising a network server, and a marketplace engine. The network server receives web service metadata associated with a web service. The web service metadata can be submitted by an asset provider. The network server is configured to receive web service computer code associated with a web service. The web service computer code can be submitted by an asset provider. The web service computer code can be implemented using the established format protocol. The network server can be configured to receive a request for the web service. The request being received from an asset consumer that can invoke the web service using the format protocol.

The marketplace engine can establish a format protocol for implementing a web service. The format protocol is established by the marketplace provider. The marketplace engine can be configured to post a web service listing on an online market of assets. The web service listing can include a portion of the web service metadata.

In another aspect, a format protocol includes a parameter data format indicative of a format in which parameters are to be passed to the web service. Alternatively, the format protocol can include a return data format indicative of a format in which return data is provided to the asset consumer once the web service is executed.

### DRAWINGS

The features and objects of alternate embodiments of the present disclosure will become more apparent with reference to the following description taken in conjunction with the accompanying drawings of various examples wherein like reference numerals denote like elements and in which:

FIG. 1 depicts a component diagram of a system for providing an Internet asset marketplace according to one embodiment.

FIG. 2 depicts a component diagram of an exemplary marketplace engine according to one embodiment.

FIG. 3 depicts a component diagram of a computing device according to one embodiment.

FIG. 4 depicts a flow diagram of a process for providing an Internet asset marketplace according to one embodiment.

FIG. 5 depicts a table of a protocol layer for Internet assets in an Internet asset marketplace according to one embodiment.

FIG. 6 depicts an exemplary user interface for submitting an Internet asset according to one embodiment.

FIG. 7 depicts an exemplary user interface for permitting an asset consumer to perform a search according to one embodiment.

FIG. 8 depicts an exemplary user interface for providing Internet asset search results according to one embodiment.

FIG. 9 depicts an exemplary user interface for providing detailed information about an available Internet asset according to one embodiment.

FIG. 10 depicts a component diagram of a system for providing an Internet asset marketplace amongst various asset providers and consumers according to another embodiment.

### DETAILED DESCRIPTION

Various methods and systems for providing an online market of Internet assets, such as branding, web services, widgets, and the like. Other Internet assets can also include marketing, sales, or other company online resources. As such, a marketplace for Internet asset inventory is disclosed. The marketplace can be utilized by one or more online business entities to co-brand websites with brands of other online or offline business entities. As utilized herein an Internet asset is a web service, computer software, media content, advertisement, and the like.

The marketplace disclosed herein is a single source for online companies to search for viable partners that provide Internet assets. In addition, partnerships with more than two participants can also be created using the marketplace disclosed herein.

In one embodiment, an Internet website functions as a portal to allow registration of company brand and assets. The Internet website can also be a customer portal to manage existing partnerships and search for potential partners based on Internet assets. The content and services can be listed for viewing.

Thus, market participants can offer Internet assets for sale, lease, and the like. Also, bidding for Internet assets can be conducted. Once a consumer is interested in a posted Internet asset, the provider of the asset and the consumer of the asset can agree on the terms of usage, and the like and the partners will integrate the Internet asset according to previously established common protocols. The common protocols can be established by the marketplace provider.

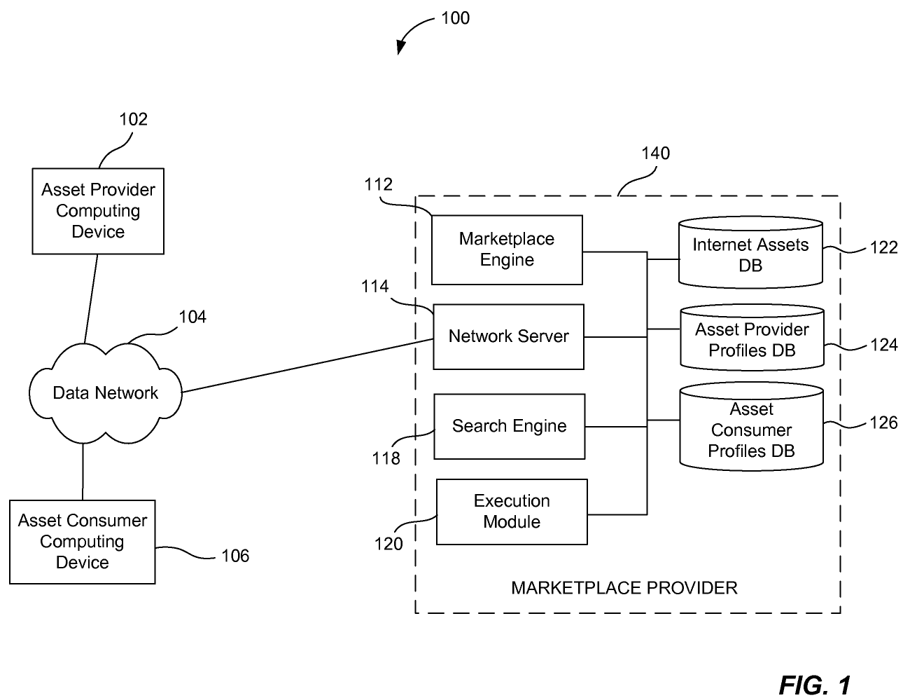

FIG. 1 depicts a component diagram of a system for providing an Internet asset marketplace according to one embodiment. A marketplace provider 140 can host one or more online marketplaces. The marketplace provider 140 can be a business entity that owns and operates a computer infrastructure connected to a data network 104 in order to provide a plurality of online services that can be accessed by an asset provider and an asset consumer. As such, Internet asset providers and Internet asset consumers may access the services provided by the marketplace provider 140 via the data network 140. In one embodiment, the data network 104 is the Internet. In another embodiment, the data network 104 is an intranet. In one embodiment, the Internet asset provider can utilize an asset provider computing device 102 to communicate the data network 104 with one or more computing modules and/or services that are part of the computer infrastructure managed by the marketplace provider 140. As such, the asset provider can upload Internet assets or provide a link destination to an Internet asset on the network 104.

In one embodiment, the asset provider computing device 102 can be configured with a web browser that allows the asset provider computing device 102 to send data to and receive data from a network server 114. The asset provider computing device 102 can communicate with the network server 114 to render web pages received from a network server 114 as well as to transmit asset provider input to the network server 114. In another embodiment, the asset provider computing device 102 can communicate through the data network 104 via any client site application configured to communicate from a portable network server 114.

In a further embodiment, the asset consumer computing device 106 can be configured with a web browser that allows the asset consumer computing device 106 to send and receive data from a network server 114. The asset consumer computing device 106 can communicate with a network server 114 via a web browser or any other client site application residing at the asset consumer computing device 106. In another embodiment, the network server 114 can be configured to receive asset metadata associated with an Internet asset from an asset provider. As previously mentioned, the asset can be an Internet asset such as a web service or space/real estate on a website for advertisement. As such, metadata associated with the Internet asset can include descriptor information that is indicative of various attributes of the Internet asset. In one example, the Internet asset is a web service, and the metadata can be related to the web service such that the web service metadata can describe the function of the web service as well as the parameters that are required to be provided to the web service, data types returned by the web service.

As such, the network server 114 can also be configured to receive the Internet asset itself or a reference or address to a network destination that references a location where the Internet asset resides. In one example, the network server 114 can receive computer code associated to a web service that can be compiled and executed by the marketplace provider 140. In another embodiment, the network server 114 can be provided with a hyperlink to a network location that references the location of the web service on the data network 104.

In another embodiment, the network server 114 can be configured to receive a request for an Internet asset. As such, the request can be received from an asset consumer through the asset consumer computing device 106. The request can trigger the invoking, use, or execution of the Internet asset. For example, upon receiving a request for a web service, the web service can be invoked and executed.

In one aspect, a marketplace provider 140 can establish a format protocol for implementing the Internet asset. The marketplace provider 140 can establish the format protocol in order to facilitate the interaction of the asset provider and the asset consumer. For example, if the asset provider is a business entity that provides credit reports to asset consumers, the marketplace provider can establish communication protocols, data transfer protocols, data type protocols such that the execution web service of providing credit reports can be seamless to both the asset provider and the asset consumer. In other words, using a common format protocol, the asset provider can create the web service according to the aforementioned format protocol such that the description of services, the data types utilized, parameters required by the web service, data returned by the web service, pricing, data types, formal presentation, and the like can be standardized. Thus, when the asset consumer invokes the web service, the asset consumer can expect a certain type of data expect to pay a certain amount of money for the usage of the web service, etc.

In another embodiment, the marketplace provider 140 can also include a marketplace engine 112. The marketplace engine 112 can be configured to establish a format protocol for implementing Internet assets. As such, the marketplace provider 140 can establish such formal protocol by configuring the network server 114 with a filtration logic that would only accept Internet asset data that is in a specific format. In another embodiment, the marketplace engine 112 can be configured with logic to determine whether the received Internet assets comply with the pre-established format protocol.

The marketplace engine 112 can also be configured to host a listing related to the Internet asset on an online market of assets. The online market of assets can be a web-based online store with which asset consumers can interact to obtain information about available Internet assets such as web services. In one example, the web service or Internet asset listing can include a portion of the Internet asset metadata that describes the Internet asset. In another example, the Internet asset listing can be a web service listing corresponding to a web service. The web service listing can include a portion of metadata describing the web service, the parameters that the web service requires, as well as data returned once the web service is invoked.

The marketplace engine 112 can be configured to receive Internet assets and/or references to Internet assets and store such data at the Internet assets database 122. The marketplace engine 112 can further store information related to asset providers at the asset provider profiles database 124 as well as consumer data at the asset consumer profiles database 126. As such, the marketplace engine 112 is generally configured with logic to permit the viewing, negotiation and transaction of Internet assets on the data network 104.

The infrastructure of the marketplace provider 140 can also include a search engine 118. The search engine 118 can be accessed via the network server 114 by an asset consumer that searches Internet assets to include in a website or any other software product of the asset consumer. Thus, the asset consumer can enter a query and submit the query to the network server 114 for processing. The network server 114 can then relay the query of the asset consumer to the search engine 118. Search engine 118 can be configured to search and retrieve a list of relevant Internet assets residing in the Internet assets database 122. For example, if the Internet asset consumer is looking for a mapping service that can be embedded in a website of the Internet asset consumer, the asset consumer can enter a query that searches for web services that provide mapping services. The search engine 118 can then search in the Internet assets database 122 for all of the available web services that provide mapping services.

In a further embodiment, an execution module 120 can also be included as part of the marketplace infrastructure. In one embodiment, the execution module 120 can be configured to execute the computer code corresponding to an Internet asset. Thus, for example, if the asset consumer requests and purchases a mapping web service, the marketplace engine 112 can be configured to communicate and store at the asset consumer profiles database 126 access to the mapping web service requested by the asset consumer. Once the asset consumer invokes the web service, the network server 114 can relay such command to the execution module 120 which in turn can be configured to retrieve the object code, pre-compiled code or any other computer code from the Internet assets database 122. The execution module 120 can then execute the code for the Internet asset residing at the Internet assets database 122. In another embodiment, the asset consumer can request the execution of the object code corresponding to an Internet asset that does not reside at the Internet assets database 122 but resides on a remote database accessible through the data network 104. In yet another embodiment, the execution module 120 is not utilized to execute or provide the Internet asset to which the asset consumer has subscribed or purchased. For example, the asset provider can execute the web service requested by the asset consumer. If the asset consumer had purchased the web service through the marketplace provider 140 and made payment, the asset provider can make the request to the marketplace provider 140 for the invocation of the web service. Network server 114 can receive such request, verify that the asset consumer has registered or has prepaid or charged the asset consumer a fee for using the web service. The network server 114 can then redirect the request to the asset provider via the data network 104. The asset provider can then execute the web service and provide the result back to the asset consumer directly via data network 104. As such, and as an example, the marketplace provider 140 can function as a relay system that keeps the accounting of fees and payments for the asset provider. In yet another embodiment, once the asset consumer has registered or paid for a requested web service, the asset consumer can submit a request directly to the asset provider via data network 104. The asset provider can then execute the web service directly at the asset provider computing device 102 or any other associated computer infrastructure and provide the return data to the asset consumer.

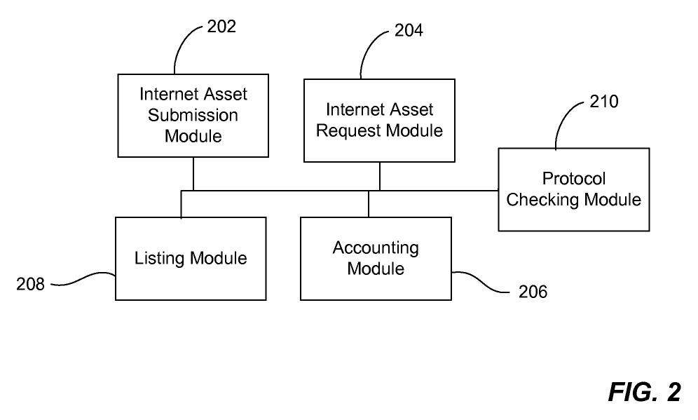

FIG. 2 depicts a component diagram of an exemplary marketplace engine according to one embodiment. An Internet submission module 202 can be included as part of the marketplace engine 102. The Internet asset submission module 202 can be configured to receive an indication and/or data associated to an Internet asset. In one example, the Internet asset submission module 202 is configured with logic to receive a hyperlink or any other pointer that references an Internet asset on a data network 104. In another embodiment, the Internet asset submission module 202 can be configured with logic to receive computer code associated with the Internet asset. In yet another embodiment, the Internet asset submission module 202 can be configured to receive metadata associated to the Internet asset being submitted. When an asset provider submits an Internet asset such as a web service, the Internet asset submission module 202 can be configured to receive computer code such as XML or any other source code that can be utilized for execution and to provide the web service. The Internet asset submission module 202 can be configured to interact with the protocol checking module 210. The protocol checking module can be configured to parse through the metadata, computer code or any other data received from the asset provider at the Internet asset submission module 202. Protocol checking module 210 can be configured with logic in order to establish whether the Internet asset being submitted complies with the format protocol established by the marketplace provider 140. In another embodiment, the protocol checking module 210 can be utilized by the market provider 140 to set parameters of the data protocol. As explained below, the marketplace provider 140 can establish and define one or more format protocols that allow asset providers and asset consumers to interact and interchange Internet assets.

The marketplace engine 112 can also include a listing module 208. The listing module 208 can be configured with logic to post listings associated with the Internet asset submitted at the Internet asset submission module 202. Thus, for example, the listing module 208 can be configured to order metadata associated with received Internet assets and display one or more Internet assets in the form of a table.

The marketplace engine 112 can also include an Internet asset request module 204. The Internet asset request module 204 can be configured with logic to receive requests from asset consumers. In one embodiment, the request received from an asset consumer can include a request to purchase the Internet asset. In another embodiment, the request received from an asset consumer includes a request to register or subscribe to an Internet asset. In yet another embodiment, a request received from an asset consumer can be a request to execute an Internet asset for which the asset consumer has previously paid.

The marketplace engine 112 can further include an accounting module 206. The accounting module 206 can be configured with logic to track usage and/or requests of Internet assets by asset consumers. As such, the accounting module 206 can determine based on the number of times that the asset consumer uses a specific Internet asset, as well as based on the payment required for executing a specific Internet asset, the fee that the asset consumer must pay to the asset provider. As such, every time the asset consumer makes a request for an Internet asset, the accounting module 208 can be configured to track and record such a request and charge the asset consumer by adding a new charge to the asset consumer profile in the asset profile consumer's database 126. Various other methods of accounting can be utilized as it is well known in the art.

While various databases have described herein, one skilled in the art will recognize that each of the aforementioned databases can be combined into one or more data repositories, and be located either locally or remotely. In addition, each of the aforementioned databases can be any type of data repository configured to store data and can be implemented using any methods of storage now known or to become known. Likewise, while various modules have described herein, one skilled in the art will recognize that each of the aforementioned modules can be combined into one or more modules, and be located either locally or remotely. Each of these modules can exist as a component of a computer program or process, or be standalone computer programs or processes recorded in a data repository.

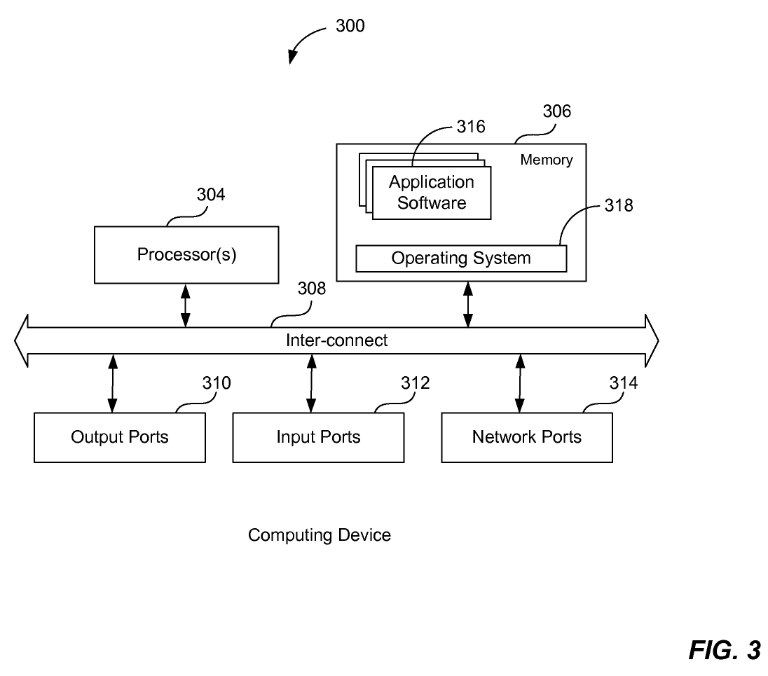

FIG. 3 depicts a component diagram of a computing device according to one embodiment. The computing device 300 can be utilized to implement one or more computing devices, computer processes, or software modules described herein. In one example, the computing device 300 can be utilized to process calculations, execute instructions, receive and transmit digital signals, as required by the advertiser computing device 102 or the advertisement creator computing device 106. The computing device 300 can be utilized to process calculations, execute instructions, receive and transmit digital signals and/or data as required by the marketplace engine 112, the network server 114, the search engine 118, and other modules, or computer software elements. The computing device 300 can be any general or special purpose computer now known or to become known capable of performing the steps and/or performing the functions described herein, either in software, hardware, firmware, or a combination thereof.

The computing device 300 includes an inter-connect 308 (e.g., bus and system core logic), which interconnects a microprocessor(s) 304 and memory 306. The inter-connect 308 interconnects the microprocessor(s) 304 and the memory 306 together. Furthermore, the interconnect 308 interconnects the microprocessor 304 and the memory 306 to peripheral devices such input ports 312 and output ports 310. Input ports 312 and output ports 310 can communicate with I/O devices such as mice, keyboards, modems, network interfaces, printers, scanners, video cameras and other devices. In addition, the output port 310 can further communicate with the display 104.

Furthermore, the interconnect 308 may include one or more buses connected to one another through various bridges, controllers and/or adapters. In one embodiment, input ports 312 and output ports 310 can include a USB (Universal Serial Bus) adapter for controlling USB peripherals, and/or an IEEE-1394 bus adapter for controlling IEEE-1394 peripherals. The inter-connect 308 can also include a network connection 314.

The memory 306 may include ROM (Read Only Memory), and volatile RAM (Random Access Memory) and non-volatile memory, such as hard drive, flash memory, etc. Volatile RAM is typically implemented as dynamic RAM (DRAM), which requires power continually in order to refresh or maintain the data in the memory. Non-volatile memory is typically a magnetic hard drive, flash memory, a magnetic optical drive, or an optical drive (e.g., a DVD RAM), or other type of memory system which maintains data even after power is removed from the system. The non-volatile memory may also be a random access memory.

The memory 306 can be a local device coupled directly to the rest of the components in the data processing system. A non-volatile memory that is remote from the system, such as a network storage device coupled to the data processing system through a network interface such as a modem or Ethernet interface, can also be used. The instructions to control the arrangement of a file structure may be stored in memory 306 or obtained through input ports 312 and output ports 310.

In general, routines executed to implement one or more embodiments may be implemented as part of an operating system 318 or a specific application, component, program, object, module or sequence of instructions referred to as application software 316. The application software 316 typically can comprises one or more instruction sets that can be executed by the microprocessor 304 to perform operations necessary to execute elements involving the various aspects of the methods and systems as described herein. For example, the application software 316 can include video decoding, rendering and manipulation logic.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions may be embodied in digital and analog communication links for electrical, optical, acoustical or other forms of propagated signals, such as carrier waves, infrared signals, digital signals, and the like.

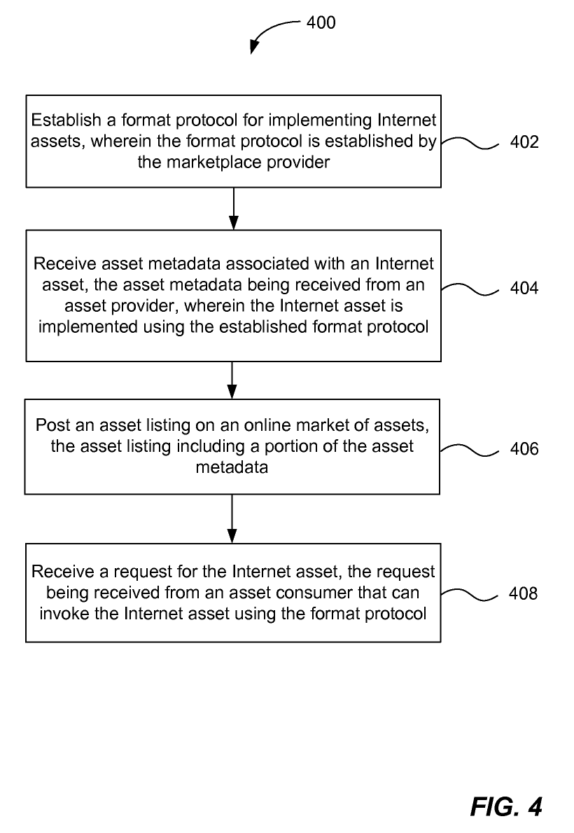

FIG. 4 depicts a flow diagram of a process for providing an Internet asset marketplace according to one embodiment. At process block 402, a format protocol is established for implementing Internet assets. In one aspect, the format protocol can be established by the marketplace provider 104. In another embodiment, the format protocol can be established by a negotiation between the asset provider and the asset consumer. Process 400 continues at process block 404.

At process block 404, asset metadata associated with the Internet asset is received. The asset metadata can be received from an asset provider. In addition, the Internet asset can be implemented using the established format protocol. Process 400 continues at process block 406.

At process block 406, an asset listing is posted on an online market of assets. The online market of assets can be a website that lists one or more Internet assets that are available for subscription or purchase. Each asset listing can include a portion of the asset metadata submitted by the asset provider. Process 400 continues at process block 408. At process block 408, a request for the Internet asset is received from an asset consumer.

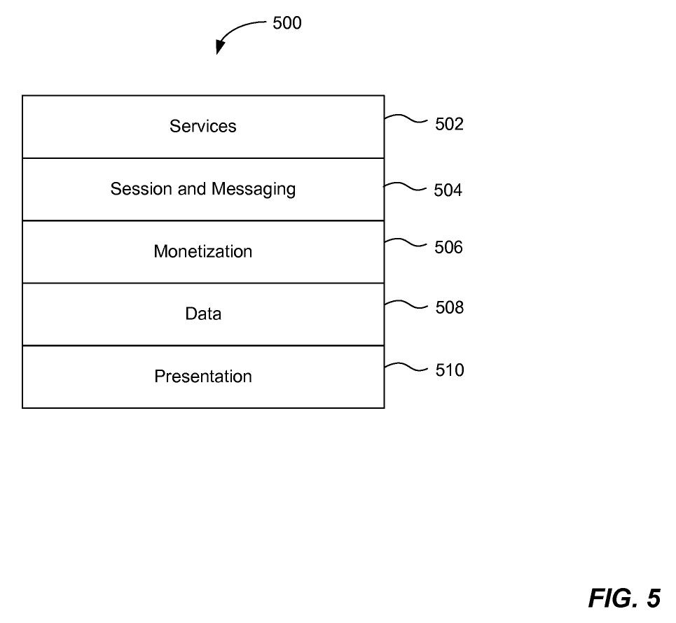

FIG. 5 depicts a table of a protocol layer for Internet assets in an Internet asset marketplace according to one embodiment. The table 500 illustrates a service layer 502, a session and messaging layer 504, a monetization layer 506, a data layer 508 and a presentation layer 510. These layers are an exemplary group of layers that can be utilized in order to define a format protocol for creating Internet assets. As such, other layers having different order or similar layers having different order can be utilized in order to define a format protocol as utilized herein. In one embodiment, the services layer can be utilized to define functionalities provided by the Internet asset. In one example, if the Internet asset is a web service, the specified functionalities can include, for example, the parameter data that needs to be passed in when invoking the web service. Additional functionality can be described according to the type of information that is returned when invoking the web service.

The session and messaging layer 504 can be utilized to describe grouping or bundling of one or more web services. Thus, for example, if an asset provider submits a group of web services as a package, the session and messaging layer can be utilized to define how web services are to be bundled together in a package. In addition, the session and messaging layer can further provide definitions on how messaging is to be performed across the data network 104. For example, protocols of communication such as error correction codes, acknowledgements, header information in messages, etc. can be defined in the session and messaging layer 504.

The monetization layer 506 can be utilized to define the pricing scheme of the Internet asset. Again, if the Internet asset is an advertising space on a website, monetization can be defined based on the click-through rate on the advertisement placed on the website space. In another example, a licensing scheme can be established such that the asset provider charges the asset consumer based on the number of users associated with the asset consumer. Various other monetization methods can be utilized and defined as part of the monetization layer 506.

Furthermore, the data layer 508 can be utilized to define the type of data and its representation when relaying such data. Thus, for example, if the data is to be compressed when transmitted, the data layer 508 can be utilized to define the type of compression utilized such that the asset consumer can be decompress the data. Likewise, the data layer 508 can be also utilized in order to define whether compression is utilized. If compression is utilized, then the data layer 508 can also be used to define the type of encryption being utilized.

Furthermore, the presentation layer 510 can be used to define how the content is to be displayed on a web browser. Thus, if the Internet asset being sold on the online marketplace is an Internet asset that is to be displayed on a website, then the presentation layer 510 can be utilized to establish the form of presentation of the Internet asset. Any of the previously described layers can be optional depending upon the type of Internet asset that is being defined according to the format protocol. For example, if the Internet asset is raw data that is transmitted as XML to the asset consumer and which is not going to be displayed on a website, the presentation layer 510 can be ignored and not used.

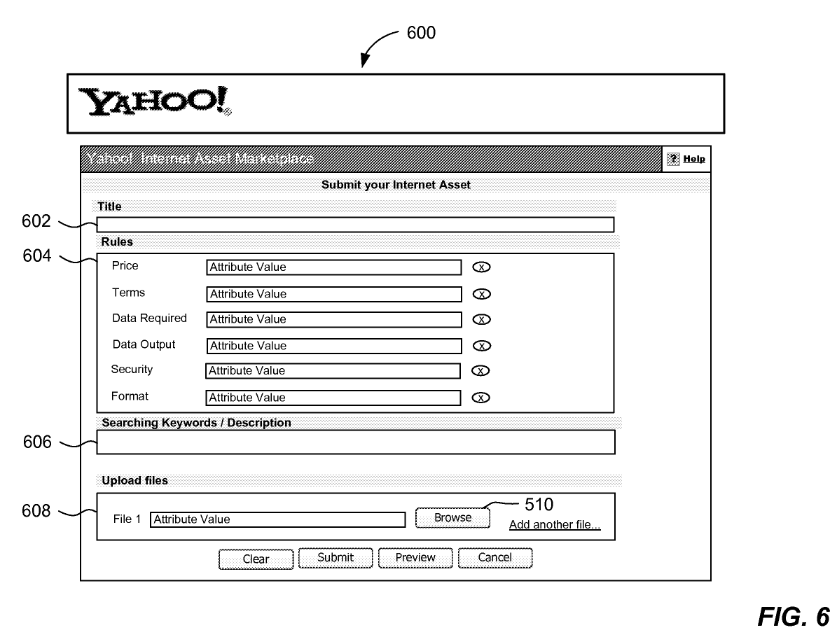

FIG. 6 depicts an exemplary user interface for submitting an Internet asset according to one embodiment. The user interface 600 provides one or more fields for entering information or metadata associated with the Internet asset. In addition, the user interface 600 provides user interface mechanisms to upload Internet asset, computer code, images or any other content related to the Internet asset itself. In another embodiment, the user interface 600 can also provide user interface mechanisms for indicating an address wherein the Internet asset resides. A field 602 can be included as part of the user interface 600 in order to enter the title of the Internet asset. Multiple fields 604 can be provided in order to enter Internet asset specific data. For example, pricing, terms, required input data, output data, security format, etc. A field 606 can also be provided such that the asset provider can enter key words or further description of the Internet asset in order to facilitate searching for the Internet asset. Furthermore, a field 608 and a browse option 610 can be included as part of user interface 600. The field 608 can be utilized by the asset provider in order to enter the file name or file location of the Internet asset being uploaded. The browse button 610 can be used to search for the specific file corresponding to the Internet asset.

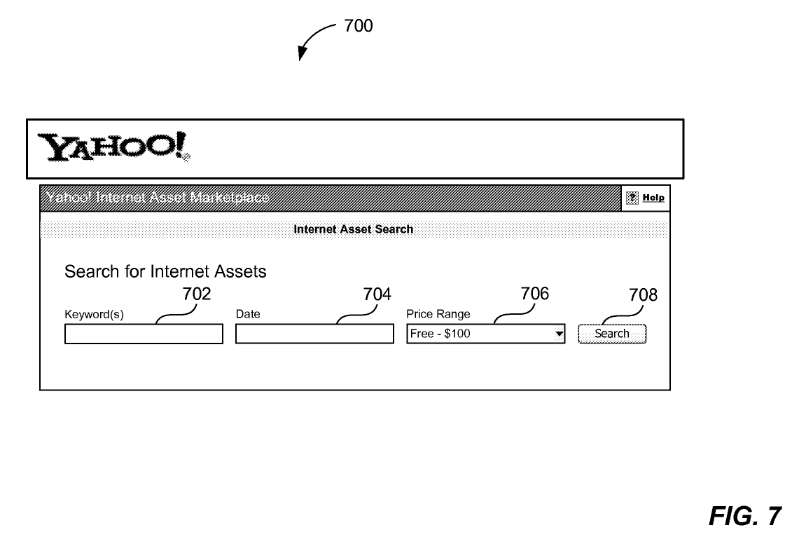

FIG. 7 depicts an exemplary user interface for permitting an asset consumer to perform a search according to one embodiment. The user interface 700 includes one or more fields for entering search criteria. As such, field 702 can be used by the asset consumer to enter search criteria corresponding to keywords. Likewise, a field 704 can be included such that the asset consumer can enter large criteria associated with the date of posting of the Internet asset. A drop-down menu 706 can also be included such that the asset consumer can select a price range of the Internet asset being searched for. Finally, a search button 708 can be used by the asset consumer to execute the search.

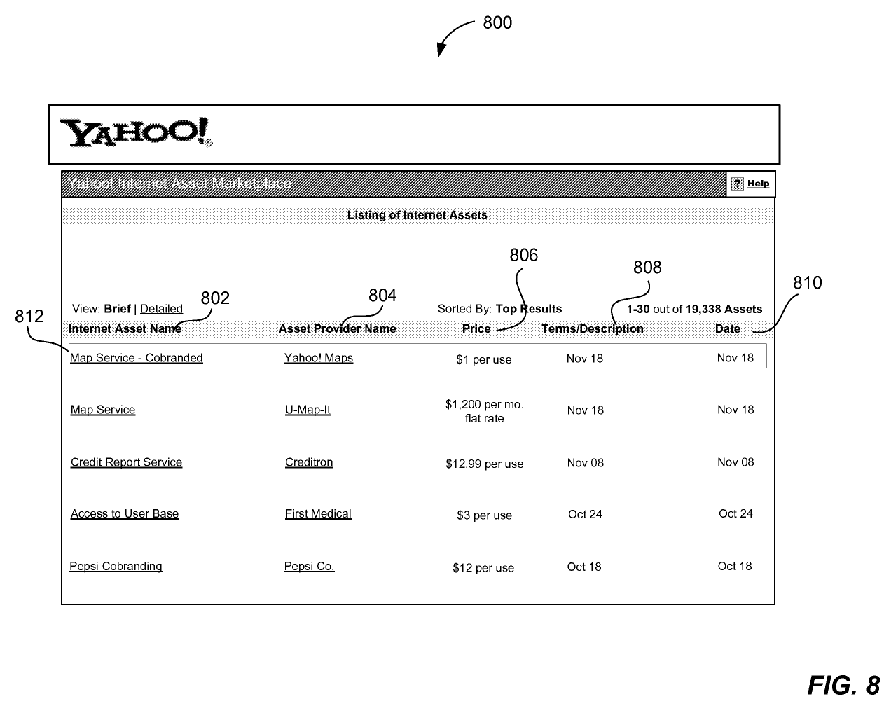

FIG. 8 depicts an exemplary user interface for providing Internet asset search results according to one embodiment. The user interface 800 displays a list of Internet assets and associated metadata. In one embodiment, various columns indicating specific metadata of the Internet assets can be included as part of the list of Internet assets. For example, a column 802 can be displayed for the Internet asset name. Likewise, a column 804 can be displayed for the name of the Internet asset provider. Furthermore, a column 806 can be provided to show the price information of each Internet asset. Likewise, a column 808 can be used and displayed to show terms, conditions and other description of the Internet asset. A column 810 can further be provided as part of user interface 800 to show the date of posting of the Internet asset.

In addition, each of the Internet assets listed can be hyperlinked to a more detailed description of what the data asset does. For example, Internet asset 812 is an Internet asset for a map service. The user interface 800 permits an asset consumer to access the link of the listed Internet asset 812 in order to find out more about the specific data required as input the output data, etc.

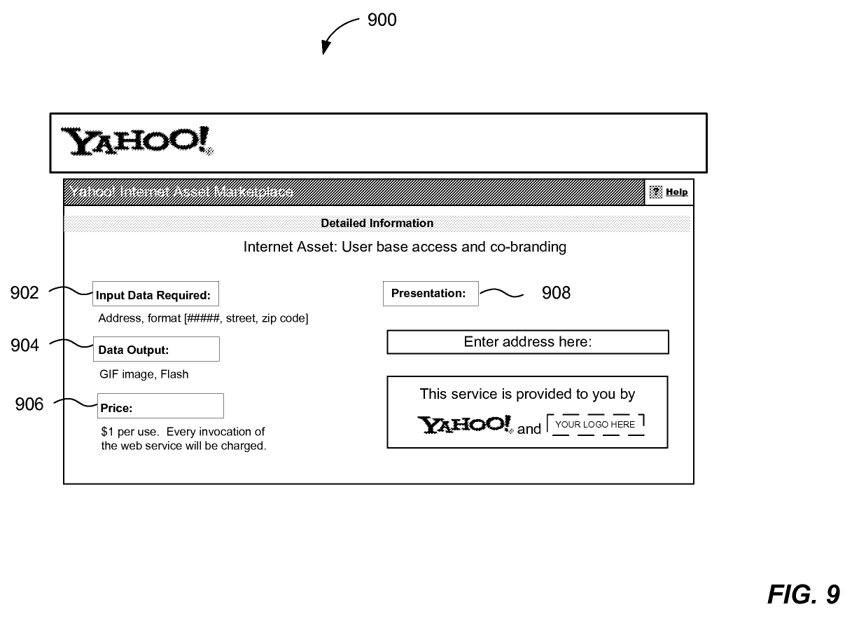

FIG. 9 depicts an exemplary user interface for providing detailed information about an available Internet asset according to one embodiment. In one example, FIG. 9 shows the detailed information of the listed Internet asset 812 of FIG. 8. A label 902 can be included as part of user interface 900 illustrating the data required as part of the input for the Internet asset at the time of relocation of the Internet asset. In one embodiment, the data required can be the address of a location such that the web service being a mapping service can map the input address to a location on a map and display such location. Thus, the output data 904 can be for example a GIF image. Likewise, the price information can also be included as part of user interface 900. For example, the pricing label 906 can illustrate that usage of the mapping service and require payment of one dollar every time the mapping service is invoked.

Furthermore, a label 908 can illustrate how the Internet asset would be co-branded on a website. Thus, in the example of user interface 900, a text box input field can be included in order to prompt the user to enter an address. In addition, a co-branding label can be provided as part of the service. Thus, for example, if the service is provided by an asset provider such as Yahoo!, the asset consumer can insert a label by explicit permission of Yahoo! indicating that the service is provided by Yahoo! and the asset consumer. The asset consumer can be for example provided with the option of entering or displaying the logo or insignia of the asset provider next to the logo of the asset provider.

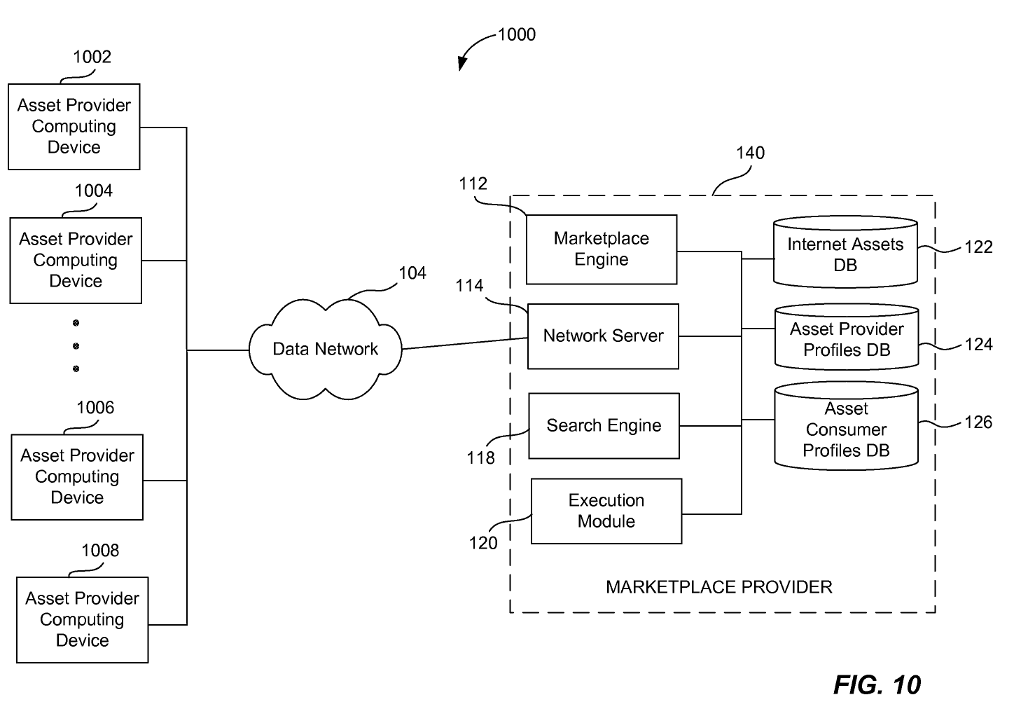

FIG. 10 depicts a component diagram of a system 1000 for providing an Internet asset marketplace amongst various asset providers and consumers according to another embodiment. As previously mentioned, the marketplace provider 140 can host one or more online marketplaces. The marketplace provider 140 provides an Internet marketplace that can be accessed by a plurality of asset providers and asset consumers. As such, Internet asset providers and Internet asset consumers may access the services provided by the marketplace provider 140 via the data network 140.

Asset providers and asset consumers can negotiate, interchange information, buy, sell, exchange, trade, and/or lease Internet assets. Asset providers and asset consumers can establish partnerships of two or more members. For example, multiple partners can working together in a deal or co-branding program. Therefore, N-way partnerships can be formed.

In one embodiment, the system 1000 can include an asset provider computing device 1002, and an asset provider computing device 1004 that allow one or more asset providers to communicate via the data network 104 and to establish partnerships with other asset providers and consumers. The asset provider computing device 1002, and the asset provider computing device 1004 can be configured similar to the asset provider computing device 102 disclosed above.

Likewise, the system 1000 can include an asset consumer computing device 1006, and an asset consumer computing device 1008 that allow one or more asset consumer to communicate via the data network 104 and to establish partnerships with other asset providers and consumers. The asset consumer computing device 1006, and the asset consumer computing device 1008 can be configured similar to the asset consumer computing device 104 disclosed above.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions can be distributed among software applications at either the client or server level or both. In this regard, any number of the features of the different embodiments described herein may be combined into single or multiple embodiments, and alternate embodiments having fewer than or more than all of the features herein described are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

1. A method of providing a market for web services, comprising:
establishing a format protocol for implementing a web service, wherein the format protocol is established by the marketplace provider;
receiving from an asset provider a web service metadata associated with a web service;
receiving from the asset provider web service computer code associated with a web service, wherein the web service computer code is implemented using the established format protocol;
posting a web service listing on an online market of assets, the web service listing including a portion of the web service metadata; and
receiving a request for the web service, the request being received from an asset consumer that can invoke the web service using the format protocol.

2. The method of claim 1, further comprising executing the web service computer code.

3. The method of claim 1, upon executing the web service computer code, returning a result of the web service to the asset consumer.

4. The method of claim 1, further comprising compiling and executing the web service computer code.

5. The method of claim 1, wherein the format protocol includes a parameter data format indicative of a format in which parameters are to be passed to the web service.

6. The method of claim 1, wherein the format protocol includes a return data format indicative of a format in which return data is provided to the asset consumer once the web service is executed.

7. A method of providing a market for Internet assets, comprising:
establishing a format protocol for implementing Internet assets, wherein the format protocol is established by the marketplace provider;
receiving, from an asset provider, asset metadata associated with an Internet asset, wherein the Internet asset is implemented using the established format protocol;
posting an asset listing on an online market of assets, the asset listing including a portion of the asset metadata; and
receiving a request for the Internet asset, the request being received from an asset consumer that can invoke the Internet asset using the format protocol.

8. The method of claim 7, wherein the Internet asset is a software module.

9. The method of claim 7, wherein the Internet asset is a web service, a web widget, a business entity brand, or a space of a website.

10. The method of claim 7, wherein the request for the Internet asset is a request to include a brand of the asset provider on a website of the asset consumer.

11. The method of claim 7, wherein the request for the Internet asset is a request for space on a webpage of the asset provider such that the asset consumer can place asset consumer data on the webpage of the asset provider.

12. The method of claim 7, further comprising:
receiving parameter data from the asset consumer;
transmitting the parameter data to the asset provider;
receiving return data from the asset provider; and
providing the return data to the asset consumer.

13. The method of claim 7, further comprising sending a link that references a network location of the asset consumer.

14. The method of claim 7, further comprising:
receiving computer code corresponding to the Internet asset; and
executing the computer code.

15. A system of providing a market for web services, comprising:
a network server that receives web service metadata associated with a web service, the web service metadata being submitted by an asset provider, wherein the network server is configured to receive web service computer code associated with a web service, the web service computer code being submitted by an asset provider, wherein the web service computer code is implemented using the established format protocol, wherein the network server is configured to receive a request for the web service, the request being received from an asset consumer that can invoke the web service using the format protocol; and
a marketplace engine that establishes a format protocol for implementing a web service, wherein the format protocol is established by the marketplace provider, the marketplace engine configured to post a web service listing on an online market of assets, the web service listing including a portion of the web service metadata.

16. The system of claim 15, wherein the format protocol includes a parameter data format indicative of a format in which parameters are to be passed to the web service.

17. The system of claim 15, wherein the format protocol includes a return data format indicative of a format in which return data is provided to the asset consumer once the web service is executed.
